(19) United States
(12) Patent Application Publication
(10) Pub. No.: US 2022/0351189 A1
(43) Pub. Date: Nov. 3, 2022

(54) DIGITAL EXCHANGE AUDITING SYSTEM

(71) Applicant: Modulus Global, Inc., Scottsdale, AZ (US)

(72) Inventor: Richard Gardner, Scottsdale, AZ (US)

(21) Appl. No.: 17/661,872

(22) Filed: May 3, 2022

Related U.S. Application Data
(60) Provisional application No. 63/201,514, filed on May 3, 2021.

(51) Int. Cl. G06Q 20/36; G06Q 20/06; G06Q 20/38

(52) U.S. Cl. CPC G06Q 20/3678; G06Q 20/065; G06Q 20/389; G06Q 20/3674; G06Q 2220/00

(57) ABSTRACT

A method and system for computing a trust score for a digital exchange is disclosed. A first counter value associated with a digital exchange is requested from a counter data store. The first counter is calculated using a first algorithm based on a set of transactions monitored in real-time at the digital exchange. Historical transaction data is accessed from the digital exchange. The historical transaction data corresponds to the set of transactions used to calculate the first counter value. A second counter value is determined using the first algorithm based on the historical transaction data. A trust score associated with the digital exchange is determined based on a comparison of the first counter value and the second counter value.

### CROSS-REFERENCE TO RELATED APPLICATIONS

This application claims the benefit of U.S. Provisional Application No. 63/201,514, filed May 3, 2021, which is incorporated by reference herein in its entirety.

### TECHNICAL FIELD

An embodiment of the present subject matter relates generally to digital exchanges and, more specifically, to a digital exchange auditing system.

### BACKGROUND

Digital exchanges provide a platform for the exchange of digital assets. For example, a digital exchange allows users to buy and/or sell digital assets, such as cryptocurrencies, non-fungible tokens (NFTs), and the like. Currently, digital exchanges operate as a decentralized digital exchange or as a centralized digital exchange. A decentralized digital exchange facilitates direct peer-to-peer transactions between users in which each transaction is directly recorded on a distributed ledger, such as a blockchain. Recording transactions to the distributed ledger provides confirmation of the completed transactions and the order in which they were processed. In contrast, a centralized digital exchange operates as a third-party between buyers and sellers to facilitate the trade of digital assets. Transactions performed using a centralized digital exchange are not peer-to-peer or recorded on a distributed ledger, as with a decentralized digital exchange. Users rely on the centralized digital exchange to monitor and process the transactions in the appropriate order. A centralized digital exchange provides the benefit of being able to perform transactions at a much faster rate than a decentralized digital exchange; however, it does not provide the assurances that transactions are processed correctly and in the appropriate order. For example, users typically rely on transactions data provided by the centralized digital exchange, which may be misreported. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for auditing a centralized digital exchange, according to some example embodiments.

FIG. 2 is a block diagram of a digital exchange auditing system, according to some example embodiments.

FIG. 3 is a block diagram of an auditing component, according to some example embodiments.

FIG. 4 is a flowchart showing a method for auditing a centralized digital exchange, according to certain example embodiments.

FIG. 5 is a block diagram illustrating a representative software architecture, which may be used in conjunction with various hardware architectures herein described.

FIG. 6 is a block diagram illustrating components of a machine, according to some example embodiments, able to read instructions from a machine-readable medium (e.g., a machine-readable storage medium) and perform any one or more of the operations or methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for auditing a centralized digital exchange. A digital exchange auditing system monitors a digital exchange (e.g., a centralized digital exchange) for purposes of verifying the accuracy of transaction data reported by the digital exchange. For example, the digital exchange auditing system updates a counter value based on transactions received by the digital exchange. The digital exchange auditing system calculates/updates the counter value using a predetermined algorithm based on data describing each monitored transaction received by the digital exchange.

The digital exchange auditing system periodically stores the counter value in a counter data store where it can be subsequently accessed for purposes of auditing the digital exchange. The counter data store may be a centralized data store or decentralized data store, such as a distributed ledger (e.g., blockchain). The digital exchange auditing system may enable users to request an audit of the digital exchange (e.g., via one or more interfaces, including user interfaces and/or application program interfaces (APIs)). In response to receiving such a request, the digital exchange auditing system accesses the counter value from the counter data store as well as transaction data from the digital exchange. The transaction data received from the digital exchange may describe transactions received by the digital exchange auditing system, as reported by the digital exchange auditing system. The digital exchange auditing system may use the predetermined algorithm to calculate a counter value based on the transaction data received from the digital exchange.

The digital exchange auditing system compares the counter value accessed from the counter data store to the counter value calculated from the transaction data received from the digital exchange to verify the accuracy of the transaction data reported by the digital exchange. For example, the digital exchange auditing system may determine a variance between the two counter values that indicates the accuracy of the transaction data reported by the digital exchange. A relatively small variance, or no variance, between the counter values indicates that the transaction data reported by the digital exchange is accurate, whereas a relatively larger variance indicates that the transaction data reported by the digital exchange is inaccurate.

The digital exchange auditing system may generate a trust score based on the variance between the two counter values. The trust score indicates a level of trust that transaction data reported by the digital exchange is accurate. For example, a relatively high trust score indicates a high level of trust that the transaction data reported by the digital exchange is accurate, whereas a relatively lower trust score indicates a low level of trust that the transaction data reported by the digital exchange is accurate. The digital exchange auditing system may generate the trust score by comparing the variance between the two counter values to threshold values. For example, a variance that exceeds a specified threshold value may indicate that the transaction data reported by the digital exchange is likely inaccurate and the digital exchange auditing system may assign a relatively low trust score to the digital exchange. As another example, a variance that is below a specified threshold value may indicate that the transaction data reported by the digital exchange is likely accurate and the digital exchange auditing system may assign a relatively high trust score to the digital exchange.

The digital exchange auditing system provides the trust score and/or other data indicating the results of the audit to the user that requested to audit the digital exchange. This provides the user with an indication of whether the digital exchange can be trusted. For example, the trust score may be presented to the user within a user interface. In some embodiments, the user interface may list trust scores determined for multiple digital exchanges, thereby allowing the user to compare the various digital exchanges.

The audit process provided by the digital exchange auditing system provides users with a level of assurance that a centralized digital exchange is not misrepresenting transaction data. As explained earlier, centralized digital exchanges may not record transactions in a distributed ledger, as with a decentralized digital exchange. Users have therefore had to rely on the digital exchange to accurately report transactions, which opens the door to potential fraud or misrepresentation. A user that is unfamiliar or uncertain about the trustworthiness of a digital exchange can simply request that the digital exchange auditing system perform an audit of the digital exchange to receive immediate and reliable data indicating the trustworthiness of the digital exchange.

In example embodiments, a method and system for computing a trust score for a digital exchange is disclosed. A first counter value associated with a digital exchange is requested from a counter data store. The first counter is calculated using a first algorithm based on a set of transactions monitored in real-time at the digital exchange. Historical transaction data is accessed from the digital exchange. The historical transaction data corresponds to the set of transactions used to calculate the first counter value. A second counter value is determined using the first algorithm based on the historical transaction data. A trust score associated with the digital exchange is determined based on a comparison of the first counter value and the second counter value.

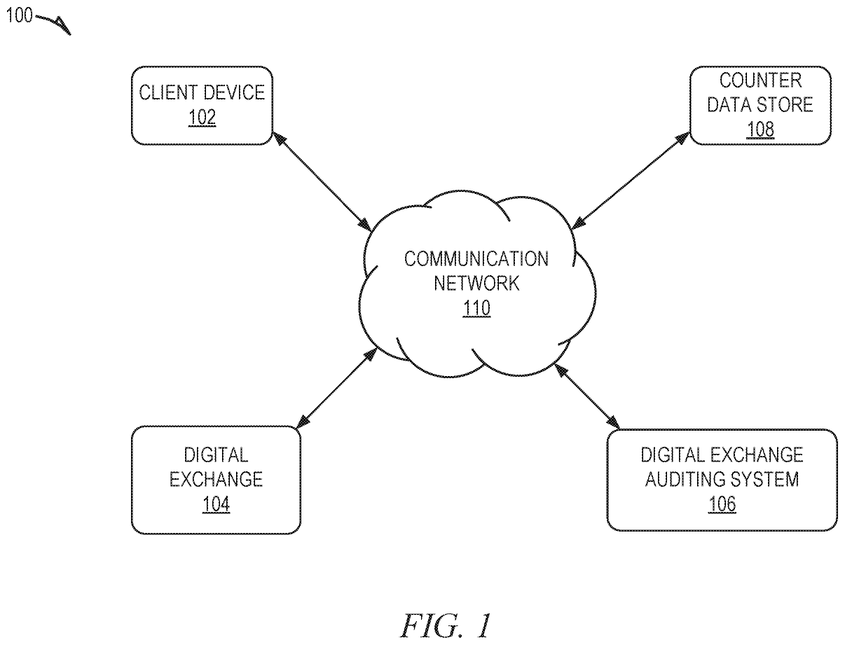

FIG. 1 shows a system 100 for auditing a centralized digital exchange, according to some example embodiments. As shown, multiple devices (i.e., client device 102, digital exchange 104, digital exchange auditing system 106 and counter data store 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

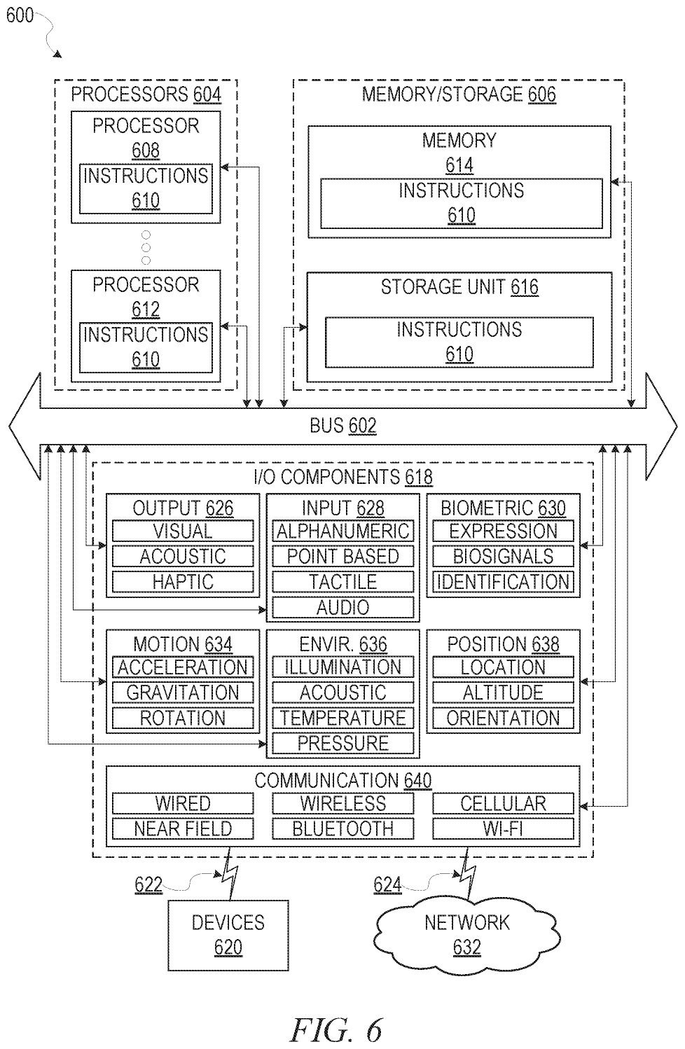

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 600 shown in FIG. 6.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

The digital exchange 104 provides a platform for the exchange of digital assets. For example, the digital exchange 104 allows users to buy and/or sell digital assets, such as cryptocurrencies, non-fungible tokens (NFTs), and the like. The digital exchange 104 may be a centralized digital exchange in which the digital exchange 104 operates as a third-party between buyers and sellers to facilitate the trade of digital assets. Transactions performed using a centralized digital exchange are not peer-to-peer or recorded on a distributed ledger, as with a decentralized digital exchange. Users therefore rely on the centralized digital exchange to monitor and process the transactions in the appropriate order.

In the system 100, users communicate with and utilize the functionality of the digital exchange 104 by using a client device 102 that is connected to the communication network 110 by direct and/or indirect communication. Although the shown system 100 includes only one client device 102 and one digital exchange 104, this is for ease of explanation and is not meant to be limiting. One skilled in the art would appreciate that the system 100 can include any number of client devices 102 and digital exchanges 104. Further, the digital exchange 104 may concurrently accept connections from and interact with any number of client devices 102. The digital exchange 104 supports connections from a variety of different types of client devices 102 such as desktop computers; mobile computers; mobile communications devices, e.g., mobile phones, smart phones, tablets; smart televisions; set-top boxes; and/or any other network enabled computing devices. Hence, the client device 102 may be of varying type, capabilities, operating systems, and so forth.

A user interacts with the digital exchange 104 via a client-side application installed on the client device 102. In some embodiments, the client-side application includes a component specific to the digital exchange 104. For example, the component may be a stand-alone application, one or more application plug-ins, and/or a browser extension. However, the users may also interact with the digital exchange 104 via a third-party application, such as a web browser, that resides on the client device 102 and is configured to communicate with the digital exchange 104. In either case, the client-side application presents a user interface (UI) for the user to interact with the digital exchange 104. For example, the user interacts with the digital exchange 104 via a client-side application integrated with the file system or via a webpage displayed using a web browser application.

The digital exchange 104 is one or more computing devices configured to facilitate a platform for the exchange of digital assets. Users may use a client device 102 to communicate with the digital exchange 104 to buy and/or sell digital assets. As explained earlier, transactions performed using a centralized digital exchange are not peer-to-peer or recorded on a distributed ledger, as with a decentralized digital exchange. Rather, a centralized digital exchange provides transaction data describing the transactions, which may be misreported. To alleviate this issue, the digital exchange auditing system 106 monitors the digital exchange 104 (e.g., a centralized digital exchange) for purposes of verifying the accuracy of the transaction data reported by the digital exchange 104. For example, the digital exchange auditing system 106 calculates/updates a counter value based on transactions received by the digital exchange 104. The digital exchange auditing system calculates/updates the counter value using a predetermined algorithm based on data describing each monitored transaction received by the digital exchange 104. The predetermined algorithm may be selected from a variety of types of algorithms and based on various types of transaction data, examples of which are discussed in greater detail below.

The digital exchange auditing system 106 periodically stores the counter value in a counter data store 108, where it can be subsequently accessed for purposes of auditing the digital exchange 104. The counter data store 108 may be placed in a database or other data storage system that is accessible to the digital exchange auditing system 106 (e.g., centralized data store or decentralized data store). For example, the counter data store 108 may be an internet accessible resource, a database that is internal to the digital exchange auditing system 106, or a distributed ledger, such as a blockchain, that is distributed over multiple computing devices. In some embodiments, the counter value may be encrypted by the digital exchange auditing system 106 prior to being stored in the counter data store 108.

The digital exchange auditing system 106 allows users to request an audit of a digital exchange 104. For example, a user can use a client device 102 to communicate with the digital exchange auditing system 106, either directly or via the digital exchange 104, to initiate an audit request. The audit request includes data identifying the digital exchange 104 to be audited, such as by including an identifier associated with the digital exchange 104.

In response to receiving an audit request, the digital exchange auditing system 106 accesses the counter value or a set of counter values from the counter data store 108. For example, the digital exchange auditing system 106 uses the identifier included in the audit request to query the counter data store 108 for the counter value(s) associated with the digital exchange 104 corresponding to the identifier.

The digital exchange auditing system 106 also gathers transaction data from the digital exchange 104 corresponding to the identifier. The transaction data received from the digital exchange 104 may describe a transaction history, as reported by the digital exchange 104. The digital exchange auditing system 106 uses the predetermined algorithm to calculate a counter value based on the transaction data received from the digital exchange 104 and compares the counter value accessed from the counter data store 108 to the counter value calculated from the transaction data received from the digital exchange 104 to verify the accuracy of the transaction data reported by the digital exchange 104. For example, the digital exchange auditing system 106 may determine a variance between the two counter values that indicates the accuracy of the transaction data reported by the digital exchange 104. A relatively small variance (or no variance) between the counter values indicates that the transaction data reported by the digital exchange 104 is accurate, whereas a relatively larger variance indicates that the transaction data reported by the digital exchange 104 is inaccurate.

In some embodiments, the digital exchange auditing system 106 may generate a trust score based on the variance between the two counter values. The trust score indicates a level of trust that transaction data reported by the digital exchange 104 is accurate. For example, a relatively high trust score (e.g., a trust score above a specified threshold) indicates a high level of trust that the transaction data reported by the digital exchange 104 is accurate, whereas a relatively lower trust score (e.g., a trust score below a specified threshold) indicates a low level of trust that the transaction data reported by the digital exchange 104 is accurate.

The digital exchange auditing system 106 may generate the trust score by comparing the variance between the two counter values to threshold values. For example, a variance that exceeds a specified threshold value may indicate that the transaction data reported by the digital exchange is likely inaccurate and the digital exchange auditing system 106 may assign a relatively low trust score to the digital exchange 104. As another example, a variance that is below a specified threshold value may indicate that the transaction data reported by the digital exchange is likely accurate and the digital exchange auditing system 106 may assign a relatively high trust score to the digital exchange.

The digital exchange auditing system 106 may provide the trust score and/or other data indicating the results of the audit to the user that requested to audit the digital exchange 104. For example, the digital exchange auditing system 106 may generate an output based on the trust score that indicates a level of trust that the digital exchange 104 is accurately reporting transactions. The digital exchange auditing system 106 may transmit the output to the client device 102 that initiated the audit request, where it may be presented to the user that initiated the audit request. For example, the output may be presented within a user interface on a display of the client device 102. This provides the user with an indication of whether the digital exchange 104 can be trusted.

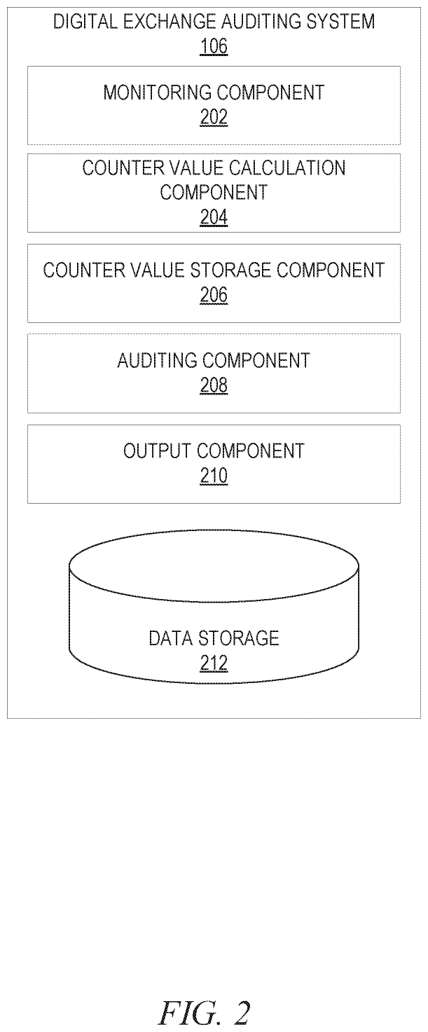

FIG. 2 is a block diagram of a digital exchange auditing system 106, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the digital exchange auditing system 106 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the digital exchange auditing system 106 includes a monitoring component 202, a counter value calculation component 204, a counter value storage component 206, an auditing component 208, an output component 210, and a data storage 212.

The monitoring component 202 monitors transactions received by a digital exchange 104. This may include monitoring buy and sell orders as well as executed transactions and requests to deposit or withdraw funds/digital assets. The monitoring component 202 may be at least partially implemented at the digital exchange 104 or a custodial service provider (e.g., BitGo, Fireblocks, Copper) used by the digital exchange 104 or any regulator such as the Securities Exchange Commission (SEC) or the Commodity Futures Trading Commission (CFTC), or any governmental agency such as the Financial Crimes Enforcement Network (FinCEN) 104. For example, a separate instance of the monitoring component 202 may be implemented at the digital exchange 104 or the custodial service provider, regulators, or governmental agencies. This allows for the monitoring component 202 to monitor transactions in real-time or near real-time as they are received at the digital exchange 104, the custodial service provider, regulators, or governmental agencies.

The monitoring component 202 generates data from monitoring the transactions, which can be shared with the other component of the digital exchange auditing system 106 and/or stored in the data storage 212. The data generated by the monitoring component 202 may include data describing the digital exchange 104 and the monitored transactions. For example, the data generated by the monitoring component 202 may include an identifier for the digital exchange 104. The data may also include data describing the transactions, such as an amount (e.g., monetary value, number of digital assets) associated with each transaction, at type of transaction (e.g., buy order, sell order, deposited, withdrawal), transaction time, and the like. In some embodiments, the monitoring component 202 may anonymize the data generated by the transactions, such as by redacting the account number, user names, social security number, and other personally identifying information.

The counter value calculation component 204 generates and updates a counter value for a digital exchange 104 based on the data generated by the monitoring component 202. For example, the counter value calculation component 204 may receive the generated data from the monitoring component 202 and/or access the generated data from the data storage 212. The counter value calculation component 204 may be at least partially implemented at the digital exchange 104 or a custodial service provider (e.g., BitGo, Fireblocks, Copper) used by the digital exchange 104.

The counter value calculation component 204 calculates the counter value using a predetermined algorithm. The predetermined algorithm may be based on any of a variety of types of data included in the data generated by the monitoring component 202. For example, the predetermined algorithm may include incrementing the counter value based on each detected buy order and decrement the counter value based on each detected sell order. The amount that the counter value is incremented and/or decremented may be a constant value such that the counter value is incremented and/or decremented by the same amount for each detected buy and/or sell order. As another example, the amount that the counter value is incremented and/or decremented may vary based on data associated with the detected buy and/or sell order. For example, the amount that the counter value is incremented and/or decremented may be based on an amount associated with the buy and/or sell order, such as monetary amount or number of digital assets to buy or sell. These are just some examples of the predetermined algorithm that may be used to calculate the counter value and are not meant to be limiting. The counter value calculation component 204 may use any of a variety of types of algorithms to calculate the counter value.

In some embodiments, the counter value calculation component 204 may calculate the counter value based on a subset of transactions detected at the digital exchange 104. For example, the counter value calculation component 204 may calculate the counter value according to a sliding window based on time or number of transactions. Calculating the counter values according to a sliding window based on time may include identifying transactions that occurred within a predetermined time period, such as within the previous 1 hour, 2 hours, and the like. Accordingly, transactions that are outside of the predetermined time period (e.g., older than 1 hour, 2 hours, etc.) are not considered when calculating the counter value.

Calculating the counter values according to a sliding window based on a number of transactions may include identifying a predetermined number of most recent transactions, such as the most recent 100 transactions, 200 transactions, and the like. Accordingly, transactions that are outside of the predetermined number of most recent transactions (e.g., not within the most recent 100 transactions, 200 transactions, etc.) are not considered when calculating the counter value.

The counter value storage component 206 stores the counter value in the counter data store 108. For example, the counter value storage component 206 may communicate with the counter data store 108 to store the counter value. In some embodiments, the counter value storage component 206 may encrypt the counter value prior to storing the counter value in the counter data store 108.

The counter value storage component 206 may associate the counter value stored in the counter data store 108 with data describing the counter value. For example, the counter value may be associated with the identifier for the digital exchange 104 corresponding to the counter value. The counter value may also be stored with data identifying the time at which the counter value was calculated (e.g., time stamp). As another example, the counter value may be stored with data identifying the transactions used to calculate the counter value. For example, the counter value may be stored with times stamp values defining the time period in which the transactions occurred, such as by including a time stamp identifying the start of the time period and a time stamp identifying the end of the time period. As another example, the counter value may be stored with values defining the range of transactions that were used to calculate the counter value, such as by including a transaction identifier identifying the earliest transaction used to calculate the counter value and another transaction identifier identifying the latest transaction used to calculate the counter value.

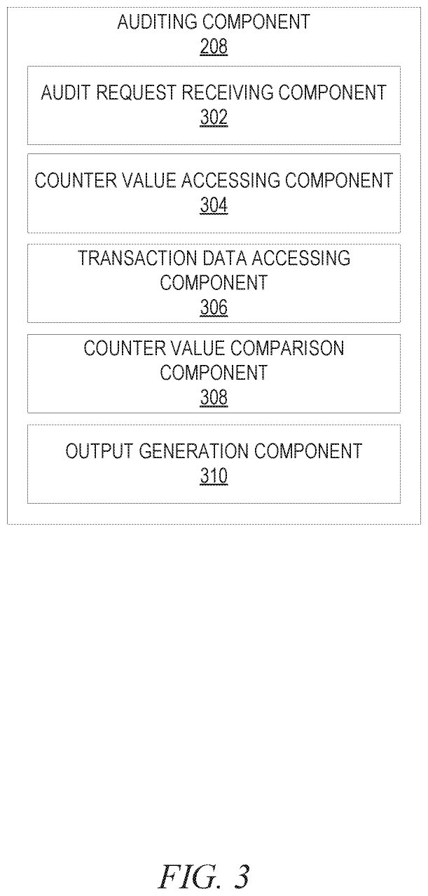

The auditing component 208 facilitates the process of auditing a digital exchange 104. This includes receiving audit requests from users, accessing the counter value associated with the digital exchange 104, accessing transaction data from the digital exchange 104, calculating a counter value based on the transaction data, and determining an output (e.g., trust score) based on a comparison of the counter values. The functionality of the auditing component 208 is described in greater detail below in relation to FIG. 3.

The output component 210 generates an output to provide in response to an audit request. For example, the output component 210 may generate an output based on the output of the auditing component 208. The output may indicate the result of the audit performed by the auditing component 208, such as by indicating the trust score calculated by the auditing component 208 and/or a level or tier of trust based on the trust score. For example, the output component 210 may compare the trust score to one or more thresholds scores to determine a level or tier of trust of the digital exchange 104.

In some embodiments, the output generated by the output component 210 may include data associated with multiple digital exchanges 104. For example, the output may include a listing trust scores determined for multiple digital exchanges 104. The listing or trust scores allows a user to directly compare performance of the various digital exchanges 104.

The output generated by the output component 210 may be provided to the requesting user in various forms. For example, in some embodiments, the output may be transmitted to the user as an email, SMS, or other type of message. In this type of embodiment, the output component 210 may generate a message and transmit the message based on contact information associated with the requesting user, such as the user's email address, phone number, and the like.

As another example, the output generated by the output component 210 may be presented to the user within a user interface. For example, the output component 210 may transmit data to the user's client device 102, which the client device 102 uses to cause a presentation within a user interface on the display of the client device 102. The output presented to the user provides the user with an indication of whether the digital exchange 104 can be trusted. In this type of embodiment, the output component 210 may update the data presented to the user within the user interface. For example, the digital exchange auditing system 106 may periodically repeat the audit process of a digital exchange 104 and the output component 210 may use the resulting output to update the user interface presented to the user. This allows the user to review changes in performance of a digital exchanges 104 in near real-time.

In some embodiments, the output component 210 may additionally provide an output based on data other than the output of the auditing component 208. For example, the output component 210 may present the user with an output generated based on a total number of deposits and withdrawals at the digital exchange 104. In this type of embodiment, output component 210 may generate a visual output, such as a line chart that represents the total number of deposits versus the total number of withdrawals at the digital exchange 104. This allows the user to monitor ratios of money flowing into or out of the digital exchange 104. The output component 210 may anonymize the data such that the actual values are not shown, such as by presenting just a continuous time series allowing the user to spot trends. Additionally, the output component 210 may present an alert if the withdrawal amount exceeds a certain percentage of the total funds (e.g., cash) available to the digital exchange.

FIG. 3 is a block diagram of an auditing component 208, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the auditing component 208 to facilitate additional functionality that is not specifically described herein. Furthermore, the various functional modules depicted in FIG. 3 may reside on a single computing device or may be distributed across several computing devices in various arrangements such as those used in cloud-based architectures.

As shown, the auditing component 208 includes an audit request receiving component 302, a counter value accessing component 304, a transaction data accessing component 306, a counter value comparison component 308, and an output generation component 310.

The audit request receiving component 302 receives audit requests to audit a digital exchange 104. An audit request may be received from a client device 102. For example, a user may use the client device 102 to communicate with the digital exchange auditing system 106 to initiate an audit request. The audit request may include data identifying the digital exchange 104 to be audited. For example, the audit request may include an identifier that identifies the digital exchange 104. The audit request receiving component 302 may communicate with the other components of the digital exchange auditing system 106 to initiate the requested audit based on a received audit request.

The counter value accessing component 304 accesses a counter value associated with the digital exchange 104 to be audited. For example, the counter value accessing component 304 uses the identifier received in the audit request to query the counter data store 108 for the counter value. This may include accessing a most recent version of the counter value or a set of most recent counter values.

The transaction data accessing component 306 accesses transaction data from the digital exchange 104. The transaction data describes a set of transactions as reported by the digital exchange 104. The transaction data accessing component 306 may use the identifier included in the audit request to identify the digital exchange 104.

In some embodiments, the transaction data accessing component 306 provides the digital exchange with data defining the scope of the transaction data being requested. For example, the transaction data accessing component 306 may provide the digital exchange 104 with time stamp values or transaction identifiers defining a window of transaction data. The time stamp values or transaction identifiers provided to the digital exchange 104 may be based on time stamp values or transaction identifiers associated with the counter value accessed from the counter data store 108. This provides for a transaction data that describes the transactions that were used to calculate the counter value retrieved from the counter data store 108. Alternatively, the transaction data accessing component 306 may use the time stamp values or transaction identifiers associated with the counter value to filter the transaction data received from the digital exchange 104.

The transaction data accessing component 306 provides the transaction data to the counter value calculation component 204. In turn, the counter value calculation component 204 calculates a counter value based on the transaction data. The counter value calculation component 204 uses the same algorithm to calculate the counter value as was used to calculate counter value stored in the counter data store. The counter value calculation component 204 provides the resulting counter value to the counter value comparison component 308.

The counter value comparison component 308 compares the counter value accessed from the counter data store 108 to the counter value calculated from the transaction data accessed from the digital exchange 104. For example, the counter value comparison component 308 may determine a variance between the two counter values.

The output generation component 310 generates an output based on the determined variance between the counter values. For example, the output generation component 310 may generate a trust score indicating the trustworthiness of the digital exchange 104. The variance between the two counter values can be used to derive whether the digital exchange 104 is accurately reporting transaction data. For example, a relatively small variance (or no variance) indicates that the digital exchange 104 is accurately reporting transaction data, whereas a relatively large variance indicates that the digital exchange 104 is not accurately reporting transaction data. Accordingly, the output generation component 310 may generate a trust score based on the variance between the counter values. For example, the output generation component 310 may compare the variance to a set of threshold values to determine the trust score. As another example, the output generation component 310 may use a predetermined algorithm to calculate the trust score. Regardless of method used by the output generation component 310, a relatively small variance will result in a higher trust score than a relatively larger variance.

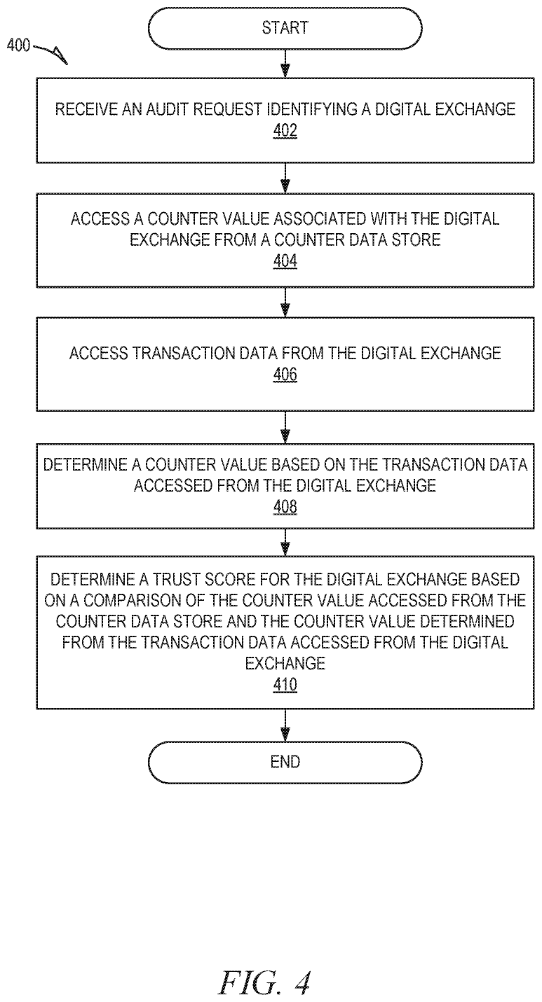

FIG. 4 is a flowchart showing a method 400 for auditing a centralized digital exchange, according to certain example embodiments. The method 400 may be embodied in computer readable instructions for execution by one or more processors such that the operations of the method 400 may be performed in part or in whole by the digital exchange auditing system 106; accordingly, the method 400 is described below by way of example with reference thereto. However, it shall be appreciated that at least some of the operations of the method 400 may be deployed on various other hardware configurations and the method 400 is not intended to be limited to the digital exchange auditing system 106.

At operation 402, the audit request receiving component 302 receives an audit request identifying a digital exchange 104. An audit request may be received from a client device 102. For example, a user may use the client device 102 to communicate with the digital exchange auditing system 106 to initiate an audit request. The audit request may include data identifying the digital exchange 104 to be audited. For example, the audit request may include an identifier that identifies the digital exchange 104. The audit request receiving component 302 may communicate with the other components of the digital exchange auditing system 106 to initiate the requested audit based on a received audit request.

At operation 404, the counter value accessing component 304 accesses a counter value associated with the digital exchange from a counter data store 108. For example, the counter value accessing component 304 uses the identifier received in the audit request to query the counter data store 108 for the counter value. This may include accessing a most recent version of the counter value or a set of most recent counter values.

At operation 406, the transaction data accessing component 306 accesses transaction data from the digital exchange 104. The transaction data describes a set of transactions as reported by the digital exchange 104. The transaction data accessing component 306 may use the identifier included in the audit request to identify the digital exchange 104.

In some embodiments, the transaction data accessing component 306 provides the digital exchange with data defining the scope of the transaction data being requested. For example, the transaction data accessing component 306 may provide the digital exchange 104 with time stamp values or transaction identifiers defining a window of transaction data. The time stamp values or transaction identifiers provided to the digital exchange 104 may be based on time stamp values or transaction identifiers associated with the counter value accessed from the counter data store 108. This provides for a transaction data that describes the transactions that were used to calculate the counter value retrieved from the counter data store 108. Alternatively, the transaction data accessing component 306 may use the time stamp values or transaction identifiers associated with the counter value to filter the transaction data received from the digital exchange 104.

The transaction data accessing component 306 provides the transaction data to the counter value calculation component 204.

At operation 408, the counter value calculation component 204 determines a counter value based on the transaction data accessed from the digital exchange 104. The counter value calculation component 204 uses the same algorithm to calculate the counter value as was used to calculate counter value stored in the counter data store. The counter value calculation component 204 provides the resulting counter value to the counter value comparison component 308.

At operation 410, the output generation component 310 determines a trust score for the digital exchange based on a comparison of the of the counter value accessed from the counter data store and the counter value determined from the transaction data accessed from the digital exchange 104. For example, the output generation component 310 generates the output based on a variance between the counter values as determined by the counter value comparison component 308.

The output may be a trust score indicating the trustworthiness of the digital exchange 104. The variance between the two counter values can be used to derive whether the digital exchange 104 is accurately reporting transaction data. For example, a relatively small variance indicates that the digital exchange 104 is accurately reporting transaction data, whereas a relatively large variance indicates that the digital exchange 104 is not accurately reporting transaction data. Accordingly, the output generation component 310 may generate a trust score based on the variance between the counter values. For example, the output generation component 310 may compare the variance to a set of threshold values to determine the trust score. As another example, the output generation component 310 may use a predetermined algorithm to calculate the trust score. Regardless of method used by the output generation component 310, a relatively small variance will result in a higher trust score than a relatively larger variance.

### Software Architecture

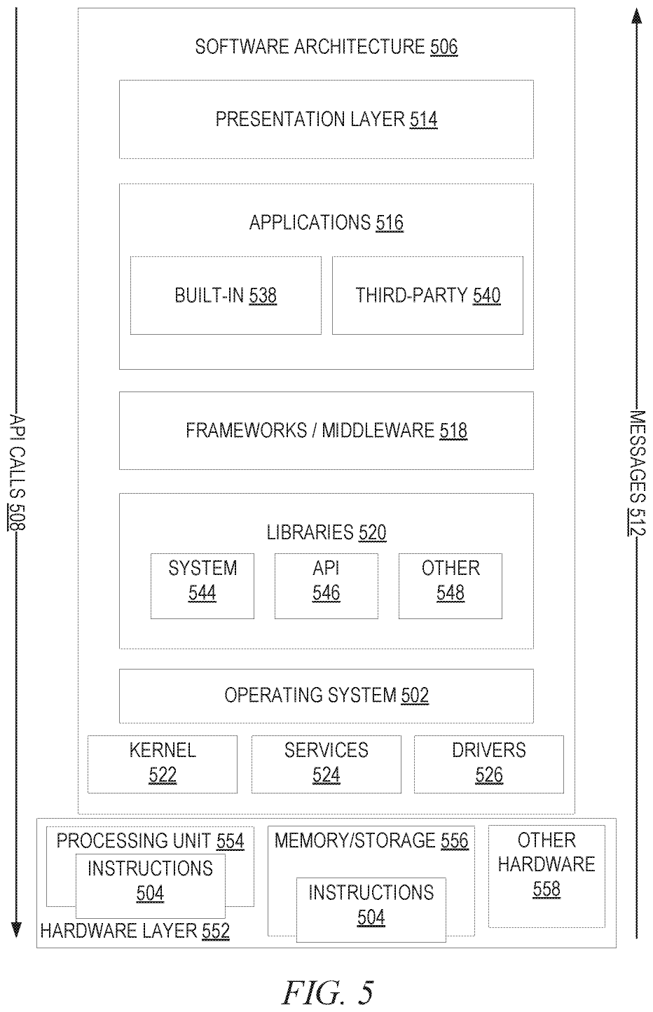

FIG. 5 is a block diagram illustrating an example software architecture 506, which may be used in conjunction with various hardware architectures herein described. FIG. 5 is a non-limiting example of a software architecture 506 and it will be appreciated that many other architectures may be implemented to facilitate the functionality described herein. The software architecture 506 may execute on hardware such as machine 600 of FIG. 6 that includes, among other things, processors 604, memory 614, and (input/output) I/O components 618. A representative hardware layer 552 is illustrated and can represent, for example, the machine 600 of FIG. 6. The representative hardware layer 552 includes a processing unit 554 having associated executable instructions 504. Executable instructions 504 represent the executable instructions of the software architecture 506, including implementation of the methods, components, and so forth described herein. The hardware layer 552 also includes memory and/or storage modules 556, which also have executable instructions 504. The hardware layer 552 may also comprise other hardware 558.

In the example architecture of FIG. 5, the software architecture 506 may be conceptualized as a stack of layers where each layer provides particular functionality. For example, the software architecture 506 may include layers such as an operating system 502, libraries 520, frameworks/middleware 518, applications 516, and a presentation layer 514. Operationally, the applications 516 and/or other components within the layers may invoke Application Programming Interface (API) calls 508 through the software stack and receive a response such as messages 512 in response to the API calls 508. The layers illustrated are representative in nature and not all software architectures have all layers. For example, some mobile or special purpose operating systems may not provide a frameworks/middleware 518, while others may provide such a layer. Other software architectures may include additional or different layers.

The operating system 502 may manage hardware resources and provide common services. The operating system 502 may include, for example, a kernel 522, services 524, and drivers 526. The kernel 522 may act as an abstraction layer between the hardware and the other software layers. For example, the kernel 522 may be responsible for memory management, processor management (e.g., scheduling), component management, networking, security settings, and so on. The services 524 may provide other common services for the other software layers. The drivers 526 are responsible for controlling or interfacing with the underlying hardware. For instance, the drivers 526 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 520 provide a common infrastructure that is used by the applications 516 and/or other components and/or layers. The libraries 520 provide functionality that allows other software components to perform tasks in an easier fashion than to interface directly with the underlying operating system 502 functionality (e.g., kernel 522, services 524, and/or drivers 526). The libraries 520 may include system libraries 544 (e.g., C standard library) that may provide functions such as memory allocation functions, string manipulation functions, mathematical functions, and the like. In addition, the libraries 520 may include API libraries 546 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 520 may also include a wide variety of other libraries 548 to provide many other APIs to the applications 516 and other software components/modules.

The frameworks/middleware 518 (also sometimes referred to as middleware) provide a higher-level common infrastructure that may be used by the applications 516 and/or other software components/modules. For example, the frameworks/middleware 518 may provide various graphical user interface (GUI) functions, high-level resource management, high-level location services, and so forth. The frameworks/middleware 518 may provide a broad spectrum of other APIs that may be used by the applications 516 and/or other software components/modules, some of which may be specific to a particular operating system 502 or platform.

The applications 516 include built-in applications 538 and/or third-party applications 540. Examples of representative built-in applications 538 may include, but are not limited to, a contacts application, a browser application, a book reader application, a location application, a media application, a messaging application, and/or a game application. Third-party applications 540 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 540 may invoke the API calls 508 provided by the mobile operating system (such as operating system 502) to facilitate functionality described herein.

The applications 516 may use built in operating system functions (e.g., kernel 522, services 524, and/or drivers 526), libraries 520, and frameworks/middleware 518 to create UIs to interact with users of the system. Alternatively, or additionally, in some systems, interactions with a user may occur through a presentation layer, such as presentation layer 514. In these systems, the application/component “logic” can be separated from the aspects of the application/component that interact with a user.

FIG. 6 is a block diagram illustrating components of a machine 600, according to some example embodiments, able to read instructions 504 from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 610 (e.g., software, a program, an application, an applet, an app, or other executable code) for causing the machine 600 to perform any one or more of the methodologies discussed herein may be executed. As such, the instructions 610 may be used to implement modules or components described herein. The instructions 610 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 600 capable of executing the instructions 610, sequentially or otherwise, that specify actions to be taken by machine 600. Further, while only a single machine 600 is illustrated, the term “machine” shall also be taken to include a collection of machines that individually or jointly execute the instructions 610 to perform any one or more of the methodologies discussed herein.

The machine 600 may include processors 604, memory/storage 606, and I/O components 618, which may be configured to communicate with each other such as via a bus 602. The memory/storage 606 may include a memory 614, such as a main memory, or other memory storage, and a storage unit 616, both accessible to the processors 604 (e.g., processors 608, 612) such as via the bus 602. The storage unit 616 and memory 614 store the instructions 610 embodying any one or more of the methodologies or functions described herein. The instructions 610 may also reside, completely or partially, within the memory 614, within the storage unit 616, within at least one of the processors 604 (e.g., within the processor's cache memory), or any suitable combination thereof, during execution thereof by the machine 600. Accordingly, the memory 614, the storage unit 616, and the memory of processors 604 are examples of machine-readable media.

The I/O components 618 may include a wide variety of components to receive input, provide output, produce output, transmit information, exchange information, capture measurements, and so on. The specific I/O components 618 that are included in a particular machine 600 will depend on the type of machine. For example, portable machines such as mobile phones will likely include a touch input device or other such input mechanisms, while a headless server machine will likely not include such a touch input device. It will be appreciated that the I/O components 618 may include many other components that are not shown in FIG. 6. The I/O components 618 are grouped according to functionality merely for simplifying the following discussion and the grouping is in no way limiting. In various example embodiments, the I/O components 618 may include output components 626 and input components 628. The output components 626 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 628 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 618 may include biometric components 630, motion components 634, environmental components 636, or position components 638 among a wide array of other components. For example, the biometric components 630 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 634 may include acceleration sensor components (e.g., accelerometer), gravitation sensor components, rotation sensor components (e.g., gyroscope), and so forth. The environmental components 636 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 638 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 618 may include communication components 640 operable to couple the machine 600 to a network 632 or devices 620 via coupling 624 and coupling 622, respectively. For example, the communication components 640 may include a network interface component or other suitable device to interface with the network 632. In further examples, communication components 640 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 620 may be another machine or any of a wide variety of peripheral devices (e.g., a peripheral device coupled via a USB).

Moreover, the communication components 640 may detect identifiers or include components operable to detect identifiers. For example, the communication components 640 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 640, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 610 for execution by the machine 600, and includes digital or analog communications signals or other intangible medium to facilitate communication of such instructions 610. Instructions 610 may be transmitted or received over the network 632 using a transmission medium via a network interface device and using any one of a number of well-known transfer protocols.

“CLIENT DEVICE” in this context refers to any machine 600 that interfaces to a communications network 632 to obtain resources from one or more server systems or other client devices. A client device 102 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 632.

“COMMUNICATIONS NETWORK” in this context refers to one or more portions of a network 632 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 632 or a portion of a network 632 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 610 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 610. The term “machine-readable medium” shall also be taken to include any medium, or combination of multiple media, that is capable of storing instructions 610 (e.g., code) for execution by a machine 600, such that the instructions 610, when executed by one or more processors 604 of the machine 600, cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a computer processor or a group of computer processors 604) may be configured by software (e.g., an application 516 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 604 or other programmable processor 604. Once configured by such software, hardware components become specific machines 600 (or specific components of a machine 600) uniquely tailored to perform the configured functions and are no longer general-purpose processors 604. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 604 (e.g., computer processor) configured by software to become a special-purpose processor, the general-purpose processor 604 may be configured as respectively different special-purpose processors (e.g., comprising different hardware components) at different times. Software accordingly configures a particular processor or processors 604, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 602) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 604 that are temporarily configured (e.g., by software) or permanently configured to perform the relevant operations. Whether temporarily or permanently configured, such processors 604 may constitute processor-implemented components that operate to perform one or more operations or functions described herein. As used herein, “processor-implemented component” refers to a hardware component implemented using one or more processors 604. Similarly, the methods described herein may be at least partially processor-implemented, with a particular processor or processors 604 being an example of hardware. For example, at least some of the operations of a method may be performed by one or more processors 604 or processor-implemented components. Moreover, the one or more processors 604 may also operate to support performance of the relevant operations in a “cloud computing” environment or as a “software as a service” (SaaS). For example, at least some of the operations may be performed by a group of computers (as examples of machines 600 including processors 604), with these operations being accessible via a network 632 (e.g., the Internet) and via one or more appropriate interfaces (e.g., an API). The performance of certain of the operations may be distributed among the processors 604, not only residing within a single machine 600, but deployed across a number of machines 600. In some example embodiments, the processors 604 or processor-implemented components may be located in a single geographic location (e.g., within a home environment, an office environment, or a server farm). In other example embodiments, the processors 604 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 600. A processor 604 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 604 (sometimes referred to as “cores”) that may execute instructions 610 contemporaneously.

What is claimed is:

1. A system comprising:
one or more computer processors;
one or more computer memories;
a set of instructions stored in the one or more computer memories, the set of instructions configuring the one or more computer processors to perform operations, the operations comprising:
requesting, from a counter data store, a first counter value associated with a digital exchange, the first counter value having been calculated using a first algorithm based on a set of transactions monitored in real-time at the digital exchange;
accessing historical transaction data from the digital exchange, the historical transaction data corresponding to the set of transactions used to calculate the first counter value;
determining a second counter value using the first algorithm based on the historical transaction data; and
determining a trust score associated with the digital exchange based on a comparison of the first counter value and the second counter value.

2. The system of claim 1, wherein the first algorithm includes incrementing the first counter value based on each detection of a buy order of plurality of buy orders received by the digital exchange and decrementing the first counter value based on each detection of a sell order of a plurality of sell orders received by the digital exchange.

3. The system of claim 1, wherein the first algorithm includes incrementing the first counter value by an amount associated with each buy or sell order of a plurality of buy or sell orders received by the digital exchange.

4. The system of claim 1, wherein the first algorithm includes incrementing the first counter value by a number of digital assets associated with each detection of a buy or sell order of a plurality of buy or sell orders received by the digital exchange.

5. The system of claim 1, wherein the historical transaction data is reported by the digital exchange.

6. The system of claim 1, wherein the first counter value is stored in the counter data store by a monitoring component that is implemented at the digital exchange or at a custodial service provider used by the digital exchange.

7. The system of claim 6, wherein the monitoring component performs the calculating according to a sliding window based on time or number of transactions.

8. A method comprising:
requesting, from a counter data store, a first counter value associated with a digital exchange, the first counter value having been calculated using a first algorithm based on a set of transactions monitored in real-time at the digital exchange;
accessing historical transaction data from the digital exchange, the historical transaction data corresponding to the set of transactions used to calculate the first counter value;
determining a second counter value using the first algorithm based on the historical transaction data; and
determining a trust score associated with the digital exchange based on a comparison of the first counter value and the second counter value.

9. The method of claim 8, wherein the first algorithm includes incrementing the first counter value based on each detection of a buy order of plurality of buy orders received by the digital exchange and decrementing the first counter value based on each detection of a sell order of a plurality of sell orders received by the digital exchange.

10. The method of claim 8, wherein the first algorithm includes incrementing the first counter value by an amount associated with each buy or sell order of a plurality of buy or sell orders received by the digital exchange.

11. The method of claim 8, wherein the first algorithm includes incrementing the first counter value by a number of digital assets associated with each detection of a buy or sell order of a plurality of buy or sell orders received by the digital exchange.

12. The method of claim 8, wherein the historical transaction data is reported by the digital exchange.

13. The method of claim 8, wherein the first counter value is stored in the counter data store by a monitoring component that is implemented at the digital exchange or at a custodial service provider used by the digital exchange.

14. The method of claim 13, wherein the monitoring component performs the calculating according to a sliding window based on time or number of transactions.

15. A non-transitory computer-readable storage medium storing a set of instructions that, when executed by one or more computer processors, cause the one or more computer processors to perform operations, the operations comprising:
requesting, from a counter data store, a first counter value associated with a digital exchange, the first counter value having been calculated using a first algorithm based on a set of transactions monitored in real-time at the digital exchange;
accessing historical transaction data from the digital exchange, the historical transaction data corresponding to the set of transactions used to calculate the first counter value;
determining a second counter value using the first algorithm based on the historical transaction data; and
determining a trust score associated with the digital exchange based on a comparison of the first counter value and the second counter value.

16. The method of claim 15, wherein the first algorithm includes incrementing the first counter value based on each detection of a buy order of plurality of buy orders received by the digital exchange and decrementing the first counter value based on each detection of a sell order of a plurality of sell orders received by the digital exchange.

17. The method of claim 15, wherein the first algorithm includes incrementing the first counter value by an amount associated with each buy or sell order of a plurality of buy or sell orders received by the digital exchange.

18. The method of claim 15, wherein the first algorithm includes incrementing the first counter value by a number of digital assets associated with each detection of a buy or sell order of a plurality of buy or sell orders received by the digital exchange.

19. The method of claim 15, wherein the historical transaction data is reported by the digital exchange.

20. The method of claim 15, wherein the first counter value is stored in the counter data store by a monitoring component that is implemented at the digital exchange or at a custodial service provider used by the digital exchange.
